(19) United States
(12) Patent Application Publication
(10) Pub. No.: US 2019/0095481 A1
(43) Pub. Date: Mar. 28, 2019

(54) GENERATING A QUERY

(71) Applicant: Microsoft Technology Licensing, LLC, Redmond, WA (US)

(72) Inventors: Gregory S. LINDHORST, Seattle, WA (US); Hemanth KUMAR, Bellevue, WA (US); Mayur K. OBEROI, Kirkland, WA (US); Reza SHOJAEI, Kirkland, WA (US); Shantanu K. PAKHARE, Redmond, WA (US)

(73) Assignee: Microsoft Technology Licensing, LLC, Redmond, WA (US)

(21) Appl. No.: 15/994,823

(22) Filed: May 31, 2018

Related U.S. Application Data
(60) Provisional application No. 62/562,340, filed on Sep. 22, 2017.

(51) Int. Cl. G06F 17/30

(52) U.S. Cl. CPC G06F 17/30389; G06F 17/30958; G06F 17/30528; G06F 17/30312

(57) ABSTRACT

According to examples, an apparatus may include at least one processor and a memory on which is stored machine readable instructions that are to cause the at least one processor to receive a first database object in a declarative application, determine an entity-relationship graph with a neighbor within n-degrees of separation from the first database object in a database, receive a selection of a second database object based on the entity-relationship graph, and generate a query including the first database object and the second database object. The instructions may also cause the processor to determine an expected type for the database value that matches the query.

### CLAIM FOR PRIORITY

This application claims the benefit of priority to U.S. Provisional Application Ser. No. 62/562,340 having the title “Intelligent Relational Query Authoring, Optimization and Execution” filed Sep. 22, 2017, the disclosure of which is hereby incorporated by reference in its entirety.

### BACKGROUND

Declarative applications may reduce the complexity of developing applications and may provide interfaces to data stored in databases such as structured query language (SQL) databases, Microsoft CRM™, SalesForce CRM™ and the like. Declarative applications often describe relationships and dependencies between objects in the application and may allow the author to describe the desired result without an explicit expression of the intermediate results. However, authors with certain levels of understanding of the underlying database schema for the database, the service protocol providing the data and/or both, may interface with databases such as SQL.

It may be technically challenging to reduce the complexity associated with interfacing with databases or services, whereby the declarative applications may be created without the author having the certain level of understanding of the underlying database schema or protocols for data services. For example, the application performance may depend on the choice of operations, and the choice of operations may stem from understanding the underlying database schema or protocols for data services. Also, it may be technically challenging to allow the author to interactively generate a query using the object to which she is exposed in the declarative application environment without an explicit understanding of the underlying database schema or service protocols.

In addition, it may be technically challenging to reduce the amount of data retrieved from the data source once the query is authored in a declarative application. The query that is generated without an understanding of the underlying database schema or service protocols is an abstraction. The query may not be optimized, may not explicitly address all of the parameters expected by the database, or may not include the details expected in a protocol. Moreover, it may be technically difficult to resolve the mismatch between the data retrieved by the query and the data expected in objects of the declarative application. For example, the query generated during application development in a declarative application may expect a one-dimensional array and the query during execution of the declarative application may return a two-dimensional array.

### BRIEF DESCRIPTION OF THE DRAWINGS

Features of the present disclosure are illustrated by way of example and not limited in the following figure(s), in which like numerals indicate like elements, in which:

FIG. 1 illustrates an apparatus for generating a query, according to an embodiment of the present disclosure;

FIG. 2 illustrates a database schema that the apparatus depicted in FIG. 1 may use to determine adjacent objects, according to an embodiment of the present disclosure;

FIG. 3A illustrates an example query that the apparatus depicted in FIG. 1 may generate in the format expected by a database, according to an embodiment of the present disclosure;

FIG. 3B illustrates an example query that the apparatus depicted in FIG. 1 may generate interactively with an author to unravel a data structure or database, according to another embodiment of the present disclosure;

FIG. 3C illustrates an example database query expected by the database generated by the apparatus depicted in FIG. 1, according to an embodiment of the present disclosure;

FIG. 3D illustrates an example abstracted query interactively generated by the apparatus depicted in FIG. 1, according to an embodiment of the present invention;

FIG. 3E illustrates an example database query expected by a database generated by the apparatus depicted in FIG. 1, according to an embodiment of the present disclosure;

FIG. 3F illustrates an example of an abstracted query corresponding to the query in FIG. 3E that the application depicted in FIG. 1 may generate, according to an embodiment of the present disclosure;

FIG. 4 illustrates a graphical user interface of an application for which the apparatus depicted in FIG. 1 may generate the query, according to an embodiment of the present disclosure;

FIGS. 5A-5C, respectively, illustrate examples of a query that the apparatus depicted in FIG. 1 may generate for an application, according to embodiments of the present disclosure;

FIGS. 5D-5F, respectively, illustrate examples of interactively generating example a query, according to embodiments of the present disclosure;

FIG. 6 illustrates a flowchart of a method for generating a query, according to an embodiment of the present disclosure;

FIG. 7 illustrates a flowchart of a method for determining the database value of a query, according to an embodiment of the present disclosure;

FIG. 8 illustrates a flowchart of a method for determining the database value of the query, according to an embodiment of the present disclosure;

FIG. 9 illustrates a flowchart of a method for generating a query, according to an embodiment of the present disclosure; and

FIG. 10 illustrates a flowchart of a method for generating a query, according to an embodiment of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures readily understood by one of ordinary skill in the art have not been described in detail so as not to unnecessarily obscure the present disclosure.

As used herein, the terms “a” and “an” are intended to denote at least one of a particular element, the term “includes” means includes but not limited to, the term “including” means including but not limited to, and the term “based on” means based at least in part on. In other instances, some methods and structures readily understood by one of ordinary skill in the art have not been described in detail so as not to unnecessarily obscure the present disclosure.

A technical problem associated with generating a query is how to generate a query that may be authored without a priori knowledge of the database schema and understood without a priori knowledge of the database schema while minimizing processor utilization and bandwidth utilization during the authoring and execution of an application. The apparatus described herein may minimize processor utilization and bandwidth utilization for at least the following reasons. The apparatus, during authoring, may use contextual information, such as a relationship context, to selectively retrieve parts of the database schema and process the database schema. Thus, the apparatus may minimize processor utilization for processing the database schema and may reduce the bandwidth utilization by reducing the size of the database schema retrieved. Similarly, during execution of an application, the apparatus may minimize processor utilization by retrieving a database value that is utilized in the application. The apparatus may also delay the database value retrieval, for instance, until the database value is to be used, to minimize the processor utilization and bandwidth utilization. Also, the apparatus may download a subset of the database values in a query based on the application context to reduce the size of the database value(s) that are retrieved and processed. The query may include retrieving an entire table as an intermediate step to retrieve a database value, such as an email address of a manager, of a salesperson for an order ID. The apparatus may retrieve the email address without retrieving the database value such as the table of managers and their associates.

According to an embodiment of the present disclosure, an apparatus may generate a query based on a dynamic entity-relationship graph and an application context in a declarative application without a priori knowledge of a database schema. To generate the query, the apparatus may receive a first database object identifier in a declarative application. The apparatus may also determine the dynamic entity-relationship graph that includes the first database object and a second database object located within n-degrees of separation from the first database object. In examples, the apparatus may limit the second database object in the query to an entity in the database located within n-degrees of separation based on the application context.

In addition, the apparatus may display a set of second database objects within n-degrees of separation from the first object in the dynamic entity-relationship graph to receive a selection and generate the query with the first database object and the second database object. In an example, the second qurey may consist of only the first database object or the second database object. The apparatus may also determine an expected type for the database entry that matches the query based on the dynamic entity-relationship graph and the application context. Thus, the apparatus may allow query generation in declarative applications without a priori knowledge of the database schema. Also, the apparatus may retrieve the database entry that matches the expected type to ensure the declarative applications retrieve the right data based on the query generated without a priori knowledge of the database schema.

A database object may be an entity, a relationship between entities, an attribute of an entity or attribute of a relationship in a database, or the like. Examples of entities may include a person, an object, a concept, an event about which data is stored in a database, or the like. In an example, an entity may be a database row or a column. Examples of a relationship between entities may include a description of how entities act upon each other or associate with each other. An attribute may be a property or characteristic of an entity or a relationship. Examples of attributes may include a key attribute of an entity or a particular key attribute of an entity such as a private key, a foreign key, or the like.

Examples of database objects may include tables, views, clusters, sequences, indexes, synonyms, or the like. For example, a database object may be a table. The table may, in turn, include other database objects, such as columns and rows. The entity-relationship graph or database schema may represent the relationship between the entities in the database, the attributes of the entities and/or the attributes of the entities. As used in this application, the database object may refer to the name of the table, view, cluster, sequence, index, synonyms, or the like. The apparatus may generate a query that includes the entities and attributes of the entities. Thus, the database objects in the query may include the entities and the attributes of the entities based on the context of the query.

According to an embodiment of the present disclosure, the apparatus may retrieve information from a database based on a query generated during application authoring or application compilation. The apparatus may project the data requirement based on the context. For example, an application context may be a relationship between the entities such as the first database object and the second database object in the declarative application. The apparatus may selectively retrieve data based on a limited projection of the data for scheduled of scheduled instructions.

According to an embodiment of the present disclosure, the apparatus may reshape the information from a database based on a query generated during application authoring or application compilation. During execution of the declarative application by the apparatus, without a priori knowledge of the database schema, the query may, in examples, produce less than or more than the anticipated data. The apparatus may reshape the data when the data retrieved does not match the type of the data expected. The type of data expected may be defined or determined during query generation. For example, the apparatus may determine the expected type of the data based on the entity-relationship graph, the first database object id, the second database object, the relationship between the first database object and the second database object, or the like. In an example, the relationship between the first database object and the second database object may be based on the application context in the declarative application. A mismatch between an expected type and the type of the database value received during execution of the query may indicate the application may expect data in a different format. The apparatus may dynamically perform reshaping based on the type definition. The type definition may describe an expected data structure for a query expected by an application.

According to an embodiment of the present disclosure, the apparatus may generate the query to access data from a database without a priori knowledge of the database schema. The apparatus may determine a second database object that is adjacent to a received first database object and may complete a query including the first database object and the second database object id. In an example, the term “adjacent” may refer to the degree of separation between entities, such as the first database object and the second database object. In an example, the apparatus may determine a second database object adjacent to the first database object based on a foreign key in the first database object. The foreign key may be an attribute of the first database object in a second database object. For example, a foreign key may express a relationship between a first table in a database and a second table. The apparatus may construct an entity-relationship graph linking the first database object and the second database object based on the relationship expressed by the foreign key. Thus, the apparatus may determine a database object within n-degrees of separation using the foreign key. The entity-relationship graph may also be described as a relationship graph. In an example, the relationship graph may include an adjacency list associating entities or nodes in the relationship graph.

A database object in a database may be an entity used to store or reference data. Examples of database objects may include tables, views, clusters, sequences, indexes, synonyms, or the like. An object may refer to columns and rows. For example, a database object may be a table, which may include objects, such as columns and rows. A relationship graph or schema may refer to a collection of database objects associated with a database or a plurality of databases.

The first database object may be deemed to be adjacent to the second database object when the first and second database objects are neighbors in a database schema or an entity-relationship graph. In examples, the apparatus may suggest the query during authoring of an application or compilation of the application. In other examples, the apparatus may generate the query during authoring of an application or compilation of the application. The apparatus may receive a first database object id, determine a second database object that is adjacent to the first database object in a relationship graph and may generate a query including the first database object and the second database object id.

In examples, the apparatus may identify the second database object without accessing the entire database schema or the entire entity-relationship graph. For instance, the apparatus may process parts of the database schema or the entity-relationship graph until the neighboring second database object is identified based on a relationship context. In addition, the apparatus may delay processing parts of the database schema, i.e., determining the entity-relationship graph until an adjacent second database object is requested. A second database object that is adjacent to the first database object may be requested during compilation of an application or authoring of an application. In examples, an author may request a set of adjacent database object id's using a terminal symbol such as the ‘.’ symbol.

In examples, the apparatus may identify an application context for the first database object. The application context may refer to the context in which the first database object appears in the declarative application, the context derived from a database schema ora relationship graph, or the like. In examples, the apparatus may derive the application context based on instructions in an application, properties of elements in an application, history of the query in an application, history of the query of an author, properties of objects using the result of the query in an application, the relationship between objects in a database schema, or the like.

The apparatus may interactively determine a query based on a first database object received from an author, the application context identifying the expected type of a database value for an instruction or a property in the declarative application. The expected type of a database value may be the format, the type of database value, or the like.

An entity-relationship graph or schema may be associated with a database or a plurality of databases. A database schema is the skeleton structure that represents the logical view of the entire database. The database schema may define how the data is organized and how the relationships among them are associated. A relationship graph may be a collection of nodes and edges. Each node may represent an entity and each edge may represent a connection or relationship between two nodes. Each node may be defined by a unique identifier, a set of outgoing edges or incoming edges. As described herein, the entities may be database objects. Adjacency lists in a relationship graph may associate each node in the graph with the collection of its neighboring nodes or edges. A database object may be adjacent to another database object when the database objects are associated as neighboring nodes in an adjacency list. In an example, an edge may be a foreign key that associates adjacent database objects.

The apparatus may identify the application context between a first database object and a second database object in a query during execution to selectively retrieve the database value. The apparatus may identify the application context between the first database object and the second database object based on a query in the declarative application. In other words, the apparatus may determine the database value to retrieve based on the historical usage of the value in the application. In another example, the apparatus may determine the database value to retrieve based on the historical usage of the author in the query in an application. In an example, the apparatus may determine the database value in the query that is displayed and may retrieve only the database value displayed. In this example, the database value may be displayed using graphical user interface objects. In examples, the apparatus may selectively retrieve the database value based on a projection of the data utilization for the query. In examples, the projection of the data utilization may be limited or reduced. For example, the projection of the data utilization may be limited to the inputs for instructions scheduled for execution. This type of selective retrieval of the database value based on a limited projection of the data utilization of the query may improve the efficiency of computing and may reduce bandwidth utilization. In examples, the apparatus may request less than the entire result matching the query based on the limited projection.

In examples, the apparatus may delay execution of a query until the results of the execution are inputs to instructions scheduled for execution. This type of “lazy evaluation” of the query may improve the efficiency of computing and may reduce bandwidth utilization. In examples, the apparatus may delay retrieving a part of the data for a query. The apparatus may delay retrieval until the author requests data, the application requests data, and/or the apparatus requests data. In examples, the author may request data through an interaction with a graphical user interface. For example, the author may request data through a swipe on a screen of an apparatus such as a mobile device. The application may retrieve the first n records for a query and retrieve the next m records for the query based on the author interaction. In examples, n may be equal to m or n may be less than m.

In examples, the apparatus may determine whether to fetch more data based on the data utilization, inputs for further instructions as they are scheduled for execution, bandwidth management, or the like.

In examples, the application may determine whether to fetch more data based on the data utilization. In examples, the apparatus may delay retrieving all data that matches a query until the author requests more data through a graphical user interface.

In examples, the apparatus may determine a query for an application. The apparatus may determine the query interactively based on inputs from the author. In examples, the apparatus may determine the query based on the relationship context. In other examples, the apparatus may determine the query based on the application context and the interactive inputs from the author. In addition, the query may be determined during authoring of the application. The apparatus may convert the generated abstract query into the query expected by a database such as an SQL database. The apparatus may determine an expected type for the generated query. The expected type may define the expectations on formatting, the number of records or the number of database fields, or the like.

The apparatus may determine a received value during execution of the query. In examples, the query may be executed during execution of the application. The apparatus may determine a received type of the received value. For example, the application context may suggest that the database value that the application expects is an email address. The apparatus may determine the received type based on the definitions in the expected type. For example, expectations on formatting, the number of records or the number of fields, or the like.

The apparatus may determine whether the received type matches the expected type. In response to the received typed matching or not matching the expected type, the apparatus may determine the database value. For example, the apparatus may determine the received type does not match the expected type. The apparatus may reshape or collapse the received value to determine the database value expected by the application or instruction utilizing the database value. The apparatus may reshape the received data when the received data is in a different format from the expected data such as a different position for a database field, or the like. The apparatus may collapse the received data when the received data contains more fields, records than the application expects. For example, the apparatus may retrieve a received data expecting a certain email address and may receive the entire database field of email addresses. In response to the received typed matching the expected type, the apparatus may use the unaltered received value to as the database value in the declarative application.

A row, a record, or a tuple in the table of a database may represent a collection of related field values of an entity (e.g., the first database object or the second database object) in the database. A field value may represent data of an entity in a tuple.

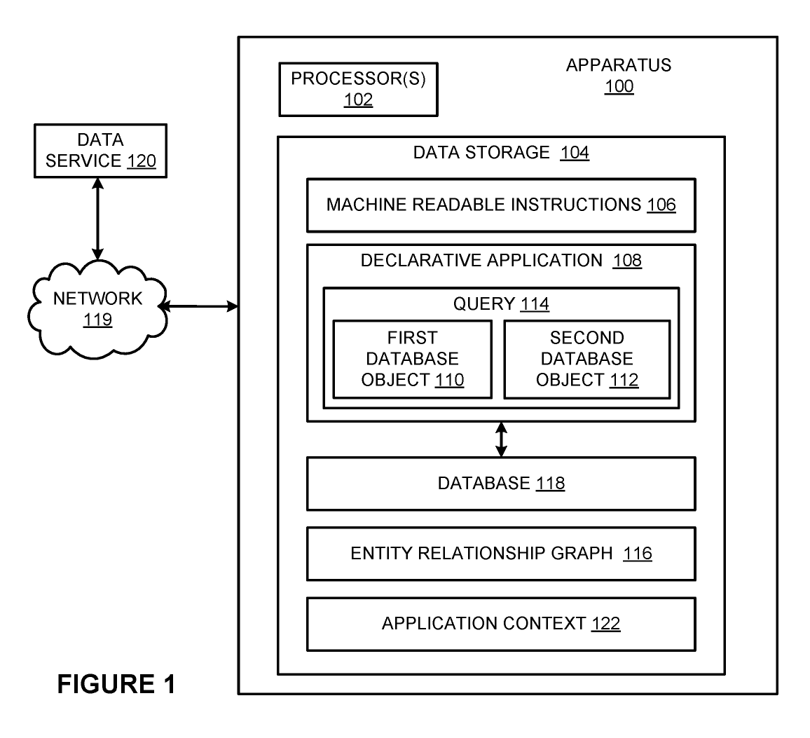

With reference to FIG. 1, there is shown a query generation apparatus 100, hereinafter the apparatus 100, according to an embodiment of the present disclosure. The apparatus 100 may include a processor 102, a data storage 104 to store machine readable instructions 106 that may be executed to generate a query 114. Examples of the query 114 that the apparatus 100 may generate are discussed in detail further below. It should be understood that the apparatus 100 may include additional components and that one or more of the components described herein may be removed and/or modified without departing from a scope of the apparatus 100.

In examples, the apparatus 100 may generate a query 114 to access data from a database without a priori knowledge of the database schema. The apparatus 100 may also generate a query 114 to access data from a data service without a priori knowledge of the data service protocol and/or the database schema. In addition, the apparatus 100 may unravel the database schema just in time based on the context, which may include, for instance, context of objects in the application, context derived from the database, context derived from a data service, context of instructions in the application, context surrounding the query 114, or the like. The apparatus 100 may unravel the database schema using foreign keys in database objects, such as tables, to traverse the database just in time based on the context. For example, the apparatus 100 may identify a foreign key in a first database object and may identify an adjacent database object linked to the first database object using the foreign key.

In examples, the apparatus 100 may generate the query 114 in a declarative application 108. In other examples, the apparatus 100 may generate the query 114 in a non-declarative application. In addition, the query 114 may include a first database object 110 and a second database object 112. The apparatus 100 may receive the first database object 110 and the apparatus 100 may determine a set of database objects from the database 118 that are adjacent to the first database object 110. In an example, the apparatus 100 may determine that the first database object 110 may be the name of a table. In an example, the apparatus 100 may determine a set of database objects that are adjacent to the first database object 110.

In an example, the apparatus 100 may determine an entity-relationship graph 116 between the first database object 110 and other entities in the database 118 that are adjacent to the first database object 110. For example, the apparatus 100 may use an entity in the first database object 110, such as a foreign key, to determine the set of database objects that are adjacent to the first database object 110. The foreign key may point to another entity (e.g., a table) in the database 118 that may be adjacent to the first database object 110. Thus, for instance, the apparatus 100 may determine the set of database objects (e.g., the table or tables) that are adjacent to the first database object 110 based on the foreign key in the first database object 110. The apparatus 100 may present the set of database objects to an author.

The apparatus 100 may receive a selection from the set of database objects to identify the second database object 112. Thus, for instance, the apparatus 100 may interactively generate the query 114 in a declarative application 108. In another example, the apparatus 100 may determine the selection based on an application context 122. That is, the apparatus 100 may dynamically determine the entity-relationship graph 116 until the adjacent second database object 112 is identified. In an example, the apparatus 100 may dynamically determine a small portion of the entity-relationship graph 116 in the entire database 118 to identify the second database object 112 based on the application context 122. The apparatus 100 may thus identify the second database object 112 without a priori knowledge of the database schema.

In an example, the database schema or the entity-relationship graph 116 of the database 118 may be relatively large. For example, the database 118 in a customer relationship management database may include millions of objects. The entity-relationship graph 116 of the database 118 may have include thousands of relationships between the objects. The apparatus 100 may selectively determine the entity-relationship graph 116 dynamically during query 114 generation. For example, the apparatus 100 may determine portions of the entity-relationship graph 116 based on the application context 122 to identify a set of database objects or even the second database object 112. Thus, the apparatus 100 may identify the second database object 112 without accessing the entire schema or the entire relationship graph 116. In an example, the apparatus 100 may determine a portion of the entity-relationship graph 116 based on the data that the application expects in an instruction of the application. The apparatus 100 may determine the query 114 based on the determined portion of the entity-relationship graph 116. In another example, the apparatus 100 may receive the first database object 110, determine the type an instruction in the application expects based on an application context 122, identify the second database object 112, and generate the query 114. In an example, the apparatus 100 may generate a database query such as an SQL query corresponding to the query 114 if accessing data from an SQL server. Although described in this application with reference to SQL, the apparatus 100 may generate a query using any other language. For example, the apparatus 100 may generate an open data protocol query (OData) using the RESTFul API.

The query 114 generated without a priori knowledge of the database schema may provide less than or more than the expected data or in some instances the wrong kind of data when executed. In an example, the apparatus 100 may determine the expected type of the database value on the execution of the query 114. The apparatus 100 may determine whether the type of the database value received during execution of the query 114 matches the expected type. The apparatus 100 may in response to the determination that the type of the database value does not match the expected type reshape or collapse the database value to match the expected type. The apparatus 100 may reshape the received value to rearrange the data to determine the database value that the instructions of the application expect. In other examples, the apparatus 100 may collapse the received value to remove the excess fields in the received value that the application does not use. The application may retain the received value in an unaltered state when the type of the expected value matches the received value.

In examples, the apparatus 100 may generate the query 114 such that the query 114 retrieves a part of the data stored in the first database object 110. In other examples, the apparatus 100 may retrieve a child object or a selection of the child object, such as a field of a database or a sub-section of a field of a database. The apparatus 100 may use selective retrieval of the data in the database objects 110, 112 such as in fields of the first database object 110 to page the field values in the application. For example, the first database object 110 may include thousands of fields. The apparatus 100 may retrieve information sufficient to execute the next instruction, such as filling the next few screens on a graphical user interface of the application.

The apparatus 100 may determine the database value of the query 114 during execution, including intelligent error correction. The apparatus 100 may generate the query 114 based on an expectation that the database 118 or the data service returns a certain type of database value that an instruction may expect in an application. For example, the application may expect the database value to be formatted in a particular way. However, the apparatus 100 may receive a different type of database value. In these instances, the apparatus 100 may determine an expected type for the query 114, in which the expected type may define the formatting, the size, the number of fields, or the like, an instruction in an application may expect. In addition, the apparatus 100 may determine the received type of the received value when the query 114 is executed and may determine whether the type of the database value received during execution of the query 114 matches the expected type.

The apparatus 100 may retrieve information from a data service 120, which may be connected to the apparatus 100 via a network 119. The network 119 may be a wide area network, local area network, or the like. Examples of the data service 120 may include cloud data services such as Microsoft CRM™, Salesforce CRM™, or the like. In an example, the apparatus 100 may determine the relationship between objects in the data service 120 based on the application programming interface, protocols used by the data service 120, contextual relationships, or the like.

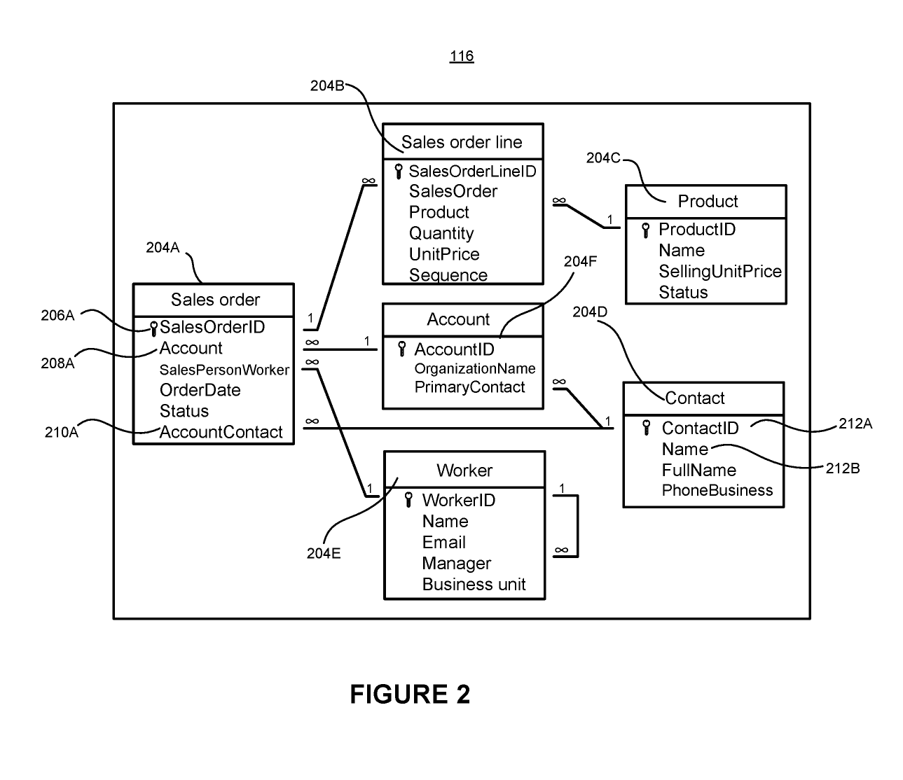

FIG. 2 shows an example of an entity-relationship graph 116 that the apparatus 100 may dynamically determine to identify adjacent objects according to an embodiment of the present disclosure. The entity-relationship graph 116 may include entities (e.g., database objects). Examples of entities in the entity-relationship graph 116 may include tables, such as Sales Order 204A, Sales Order Line 204B, Product 204C, Contact 204D, Worker 204E, and Account 204F. The entities 204A-204F may include various database fields. For instance, the entity (e.g., database object) Sales Order 204A may include the database fields SalesOrderID 206A, Account 208A, SalesPersonWorker, OrderDate, Status, and AccountContact 210A.

The apparatus 100 may treat the database fields in the entities 204A-204F as database objects to generate the query 114. In examples, the apparatus 100 may use the children of the database object, such as the database fields, as a second database object to generate the query 114 based on the context. The entities (e.g., database object) Sales Order 204A and the Sales Order Line 204B may exhibit a one to many relationship, e.g., there may be multiple Sales Order Line entities for each Sales Order entity. The entity Sales Order 204A and Account 204F may exhibit a many to one relationship, e.g., there may be one Account entity for many Sales Order entities in the database. The entities Sales Order 204A and Worker 204E may exhibit a many to one relationship, e.g., there may be many Sales Order entities associated with each Account entity. The entities Sales Order 204A and Contact 204D may exhibit a many to many relationship, e.g., there may be many Sales Order entities associated with many Contact entities. The apparatus 100 may treat the entities as database objects while generating the query 114, which may enable the apparatus 100 to traverse tables and sub-contents of tables seamlessly.

The apparatus 100, as discussed above with reference to FIG. 1, may unravel the entity-relationship graph 116 dynamically and/or interactively without the author having to understand the relational structure. In examples, the apparatus 100 may receive the first database object 110, such as the Sales Order 204A, from the author. The apparatus 100 may then receive a symbol ‘.’ and the apparatus 100 may use the ‘.’ symbol to dynamically generate the entity-relationship graph 116 to identify the database objects that are adjacent to the SalesOrder 204A. In other examples, the apparatus 100 may use a notation other than ‘.’ such as one or more Unicode characters to begin dynamic generation of the entity-relationship graph 116. For example, the apparatus 100 may determine the database objects adjacent to the first database object 110, such as AccountContact 210A, Account 208A, or the like. These database objects may be fields of the first database object (e.g., the SalesOrder 204A).

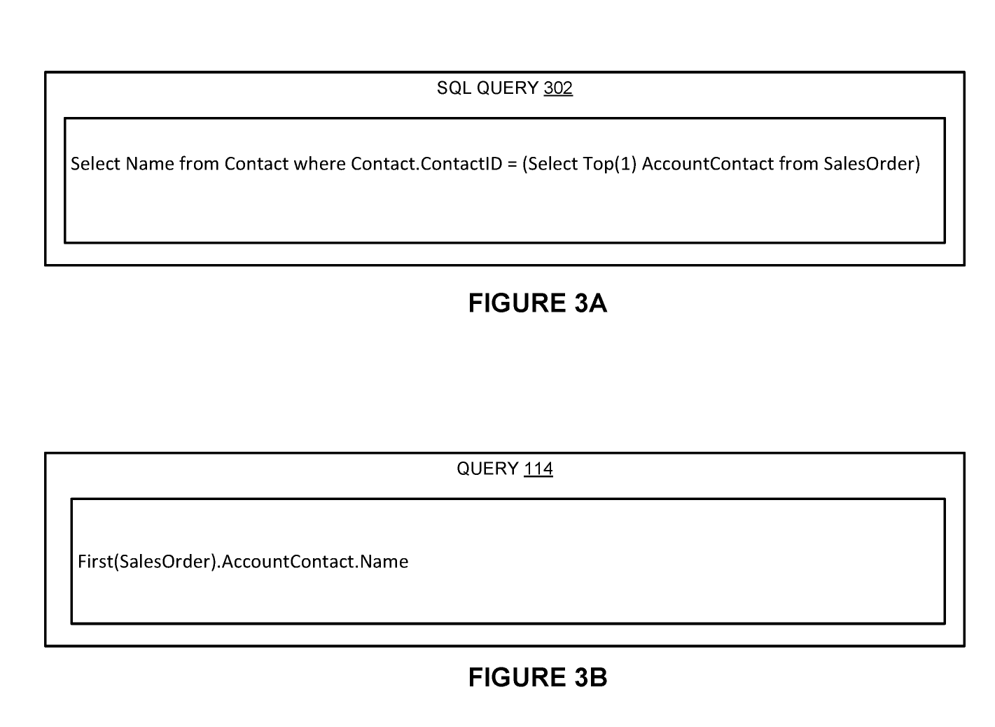

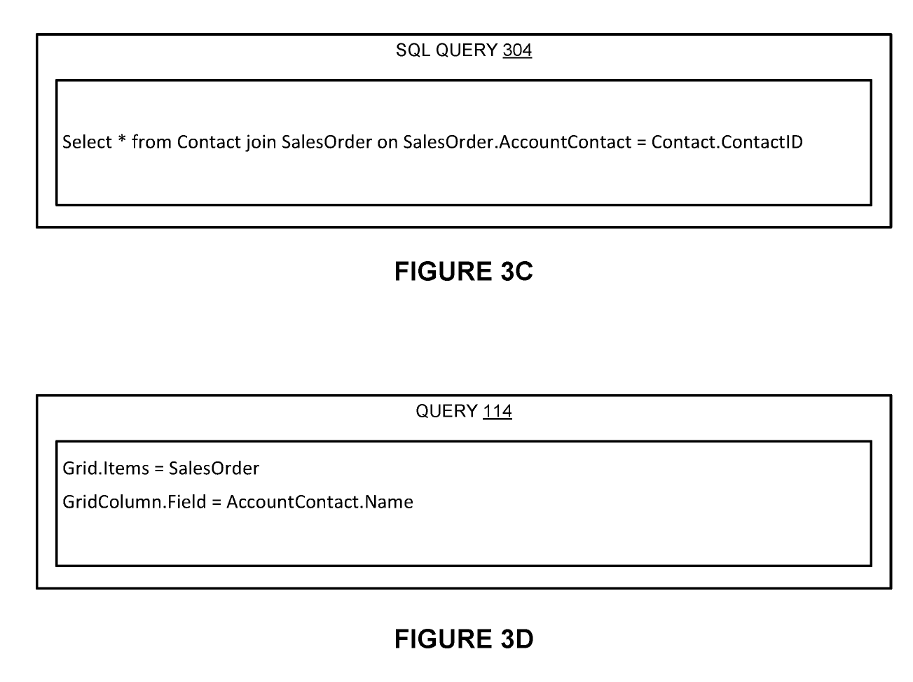

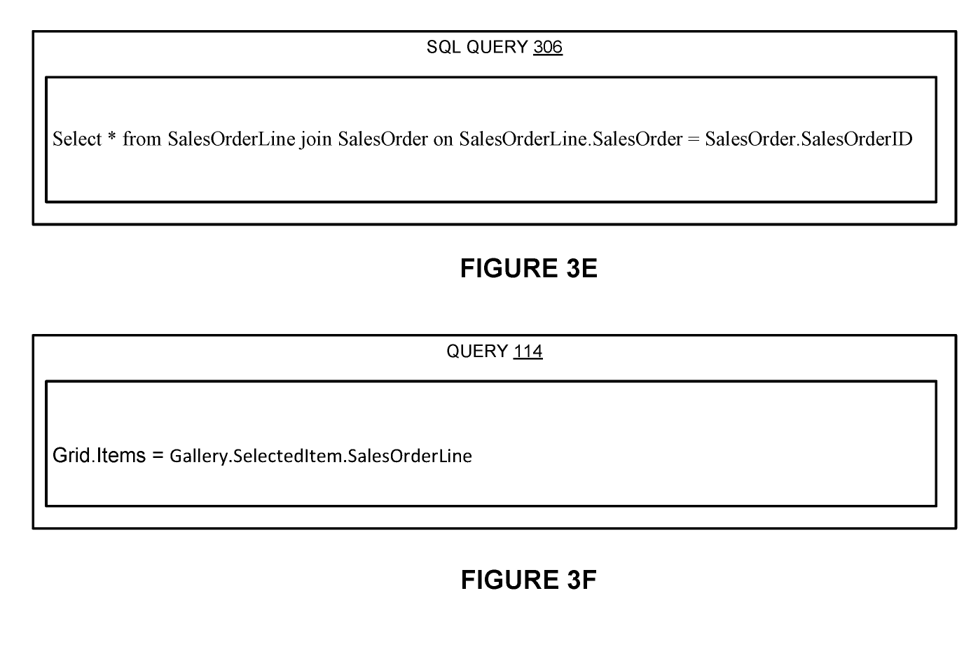

The apparatus 100 may perform lazy evaluation of the entity-relationship graph 116. In an example, the entity-relationship graph 116 for the entire database may be very large, e.g., may contain hundreds or thousands of entities, and may have significant performance overheads if the entire entity-relationship graph 116 is generated. In examples, the apparatus 100 may process a part of the entity-relationship graph 116 starting with the objects that are described in the first database object 110, such as a foreign key, to determine a set of database objects. In these examples, the apparatus 100 may prompt the author to select one object from the set of database objects. The apparatus 100 may also determine the query 114 as is further discussed below with respect to FIGS. 3A-3B.

FIG. 3A illustrates an example of a database query such as an SQL query 302 that the database 118 expects. FIG. 3B illustrates an example query 114 generated by the apparatus 100 to interactively unravel the database schema to allow an author to generate the query without understanding the underlying database schema 202. In examples, the apparatus 100 may interactively generate the query 114 as discussed above with reference to FIG. 1. The apparatus 100 may receive the database object SalesOrder 204A from the author and may determine the adjacent database objects to the database object SalesOrder 204A. In an example, the author may use the expression First to differentiate between a certain record in the overall SalesOrder 204A database object which may contain may records. As described with reference to FIG. 1, the apparatus 100 may use the application context 122 to determine a set of adjacent database objects. In an example, the apparatus 100 may determine a second database object 112, such as the AccountContact 210A, by presenting the author with a subset of the database objects that are adjacent to the Sales Order 204A.

In examples, the apparatus 100 may present the subset of the database objects that are adjacent to the Sales Order 204A upon detecting the ‘.’ symbol, or another symbol, based on the dynamic entity-relationship graph 116. The apparatus 100 may also delay evaluation of the adjacent database objects until the author enters the ‘.’ symbol, or another symbol, to avoid fetching data or using processing power that may not be needed based on the context. The apparatus 100 may receive an input from the author via a user interface indicating selection of AccountContact 210A as the second database object 112. The apparatus 100 may receive a second termination symbol ‘.’, or another symbol, from the author, and the apparatus 100 may determine the object adjacent to the database object SalesOrder.AccountContact such as a child object in the table AccountCountact 210A. In this example, SalesOrder.AccountContact may filter the rows of AccountContact 210A to a database value or a set of database values that are associated with the SalesOrder 204A based on their relationship. In examples, the apparatus 100 may use the child object as a second database object 112 to generate the query 114. The apparatus 100 may determine the application context 122 to identify a third database object. The apparatus 100 may also determine that the partially formed query “SalesOrder.AccountContact” already accessed a table and a database field based on the application context 122.

The apparatus 100 may dynamically determine the entity-relationship graph 116 to objects adjacent to AccountContact 210A. For example, apparatus 100 may determine the database object adjacent to AccountContact 210A may be in a different database object because of the context available from the partially formed query. In an example, the apparatus 100 may determine that the database object 204A may be related to the database object Contact 204D by a foreign key. The apparatus 100 may use the application context 122 as a foreign key to identify adjacent database objects, e.g., dynamically extend the entity-relationship graph 116. In other examples, the apparatus 100 may determine the application context 122 based on the historical query of the author, other query in the application 108, or the like. The apparatus 100 may return a subset of database objects to the author and may receive a selection such as “Name” from the author. In examples, the apparatus 100 may skip the foreign key data object Contact ID 212A to generate “First(SalesOrder).AccountContact.Name”—the query. In this example, the apparatus 100 may determine that the foreign key data object Contact ID 212A links the Sales Order 204A to the data object Contact 204D. The apparatus 100 may also generate the SQL query 302 as shown in FIG. 3A, including the SalesOrder 204A, AccountContact 210A and name 212B database objects. In addition, the apparatus 100 may generate the SQL query 302 as required based on the query 114 as shown in FIG. 3B.

In examples, the apparatus 100 may use the application context 122, such as a value of an object, in the AccountContact 210A that the application 108 may expect to determine the adjacent database objects. For example, the apparatus 100 may determine from the context that the application 108 is interested in a Contact with a specific Contact ID. The apparatus 100 may use this contextual information to dynamically determine the entity-relationship graph 116. The apparatus 100 may thus determine the second database object AccountContact and may generate the query 114. The apparatus 100 may also generate the SQL query 302 based on the query 114.

FIG. 3C illustrates an example of a database query such as an SQL query 304 expected by the database 118 to retrieve a table of information. The SQL query 302 discussed above with reference to FIG. 3A may retrieve information one order at a time. The apparatus 100 may generate an abstracted query shown in FIG. 3C based on the inputs from the author. The apparatus 100 may then as shown in FIG. 3D generate the SQL query 304. The apparatus 100 may use the application context 122 to retrieve either one order at a time or multiple orders. The apparatus 100 may determine the expected type for the database value, e.g., that the application expects a table from the instructions Grid.Items=SalesOrder. In another example, the apparatus 100 may determine that the instruction creates a grid control that points to the SalesOrder 204A database object and therefore the author expects all of the records to be displayed. Thus, the apparatus 118 may determine the expected type for the database value upon execution of the query 114. In this example, the database value has a type table. In an example, the apparatus 100 may use the expected type of the database value to reshape, collapse or to use the received database value during evaluation of the query.

FIG. 3E illustrates an example of an SQL query 306 determined by the apparatus 100 based on the dynamically generated query 114. The apparatus 100 may determine the expected type, in a certain context in the declarative application is a query 114 that retrieves database value with a one to many relationship. The apparatus 100 may determine the query 114 shown in FIG. 3F as an abstraction based on the application context and/or the inputs from the author. The apparatus 100 may then generate the SQL query 306 to retrieve a table of the line items for a particular SalesOrder 204A. Thus, the apparatus 100 may determine a type of the database value when the query 114 is run. In this example, the database value has an expected type of a line item in a table. In an example, the apparatus 100 may use the expected type of the database value to reshape, collapse or to use the received database value during evaluation of the query.

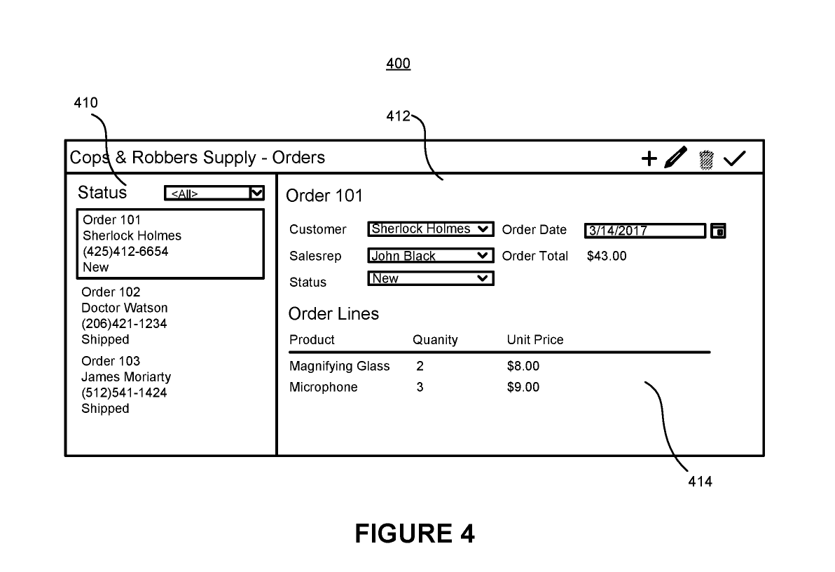

FIG. 4 illustrates an example of a graphical user interface 400 of an application 108 for which the apparatus 100 may generate the query 114, according to an embodiment of the present disclosure. The graphical user interface 400 may be presented to the author of the application 108. In an example, the apparatus 100 may determine the application context 122 based on the code segment for the left-hand pane 410. For example, the apparatus 100 may determine the left-hand pane 410 expects a table based on the use of Gallery.Items. The apparatus 100 may determine the application context 122 based on the code segment “Form.Item=Galary.SelectedItem” for the right-hand panel 412. The application context 122 in this example, may indicate that the left-hand pane 410 expects table when the query is executed. In another example, the apparatus 100 may determine application context 122 based on the instruction “Grid.Items=Galary.SelectedItem.Orderline” for the bottom right-hand panel. The application context 122 in this example may indicate that the bottom right-hand pane 410 expects the database value retrieved to be a table when the query is executed.

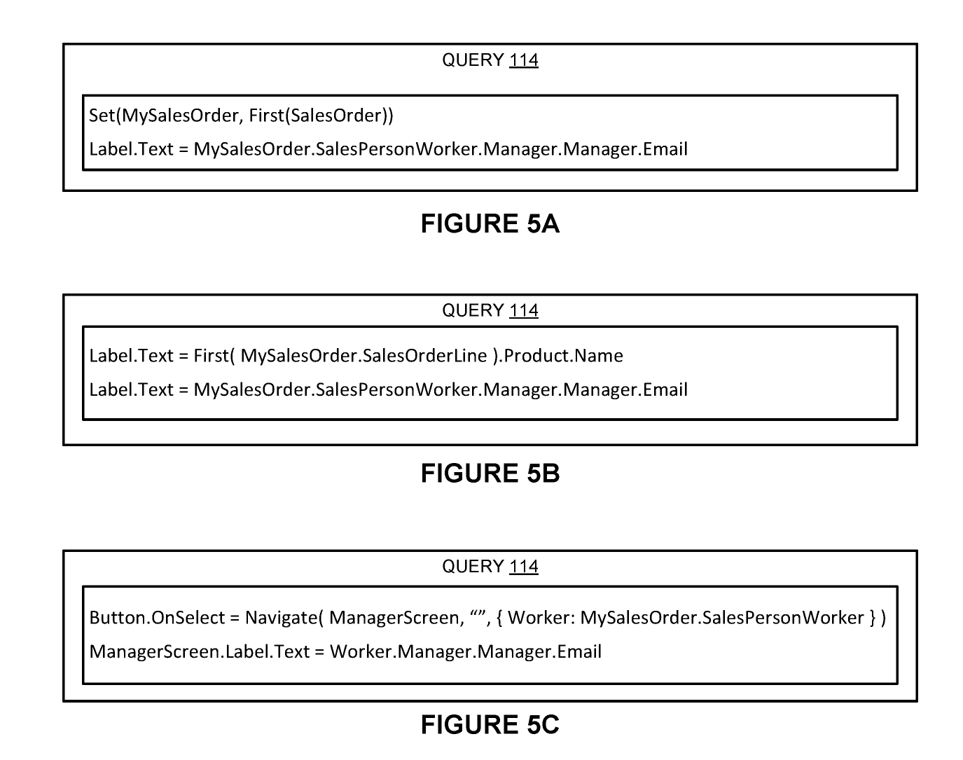

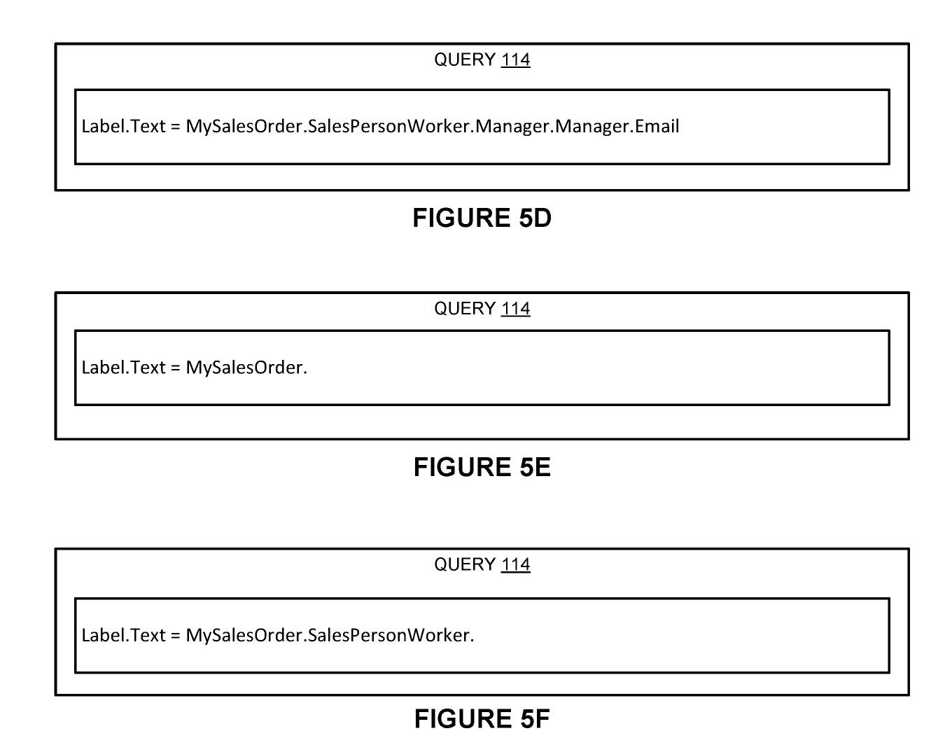

FIG. 5A illustrates an example of the query 114 that the apparatus 100 may generate for the application 108. The apparatus 100 may determine the query 114 to display the Email address of the Manager. For example, the apparatus 100 may interactively generate the instruction with the query 114 such as “Label.Text=MySalesOrder.SalesPersonWorker. Manager. Manager.Email” to display the Email address of the manager in the database object Worker 204E that corresponds to the SalesOrder database object 204A. In an example, the author may use the Set (MySalesOrder, First (SalesOrder)) to address the first entry in the SalesOrder database object 204A. The apparatus 100 may dynamically generate a portion of the entity-relationship graph 116 to determine the objects adjacent to the SalesOrder. The apparatus 100 may receive a selection from the objects adjacent to the SalesOrder in the entity-relationship graph 116 such as the SalesPersonWorker. The apparatus 100 may determine the objects adjacent to the object SalesPersonWorker. The apparatus 100 may dynamically determine a portion of the entity-relationship graph 116 to present objects including the Manager. The apparatus 100 may dynamically determine a portion of the entity relationship graph 116 to present objects including the Manager.Email. The apparatus 100 may also receive a selection from the author to generate the query 114. For example, the author may pick one of the database objects presented when presented with a choice of adjacent objects. The apparatus 100 may also determine the type of database value when the query 114 is executed. For example, the apparatus 100 may determine the query 114 may be expected to return an email address for a manager associated with a certain sales order.

FIG. 5B illustrates another example of the query 114 that the apparatus 100 may generate for the application 108. Similar to FIG. 5A, the apparatus 100 may interactively generate an instruction with the query “Label.Text=First (SalesOrder.SalesOrderLine). Product.Name” to display a product name in the database object SalesOrder 204A. In an example, the apparatus 100 may generate the query 114 using a dynamically generated entity-relationship graph 116. For example, the apparatus 100 may determine the type of the database value expected is a Text based on the “Label.Text” portion of the code. In an example, the apparatus 100 may receive the first database object SalesOrder from the author. The apparatus 100 may also dynamically generate the entity-relationship graph 116 partially to identify objects that are within n-degrees from the SalesOrder 204A object. For example, the apparatus 100 may identify a subset of objects including the SalesOrderLine 204B object.

The apparatus 100 may also receive a selection from the author, e.g., SalesOrderLine. The apparatus 100 may determine the object adjacent to the SalesOrderLine 204B object by dynamically determining a portion of the entity-relationship graph 116. The apparatus 100 may then receive a selection from the author “Product”, then similarly “Name.” The apparatus 100 may continue to dynamically generate the next portion of the entity-relationship graph 116 until the application context 122 is satisfied. In this example, the apparatus 100 may retrieve objects adjacent to the last object in the query 114 until the expected type of database value in the code or instruction matches the database value returned when the query 114 is executed. In this example, based on the application context, the apparatus 100 may identify that an email address is expected and may generate the query 114 that retrieves the email address.

FIG. 5C illustrates an example of the query 114 from FIG. 5B expressed differently. The apparatus 100 may interactively generate the instruction including the query 114. In FIG. 5C, the SalesPersonWorker is a child object of the database object SalesOrder 204A. Also, the SalesPersonWorker is an adjacent object to the first entry of database object SalesOrder 204A. The apparatus 100 may pass the child object SalesPersonWorker from a first graphical user interface screen to another. In the second screen, the information about the manager of the manager may be requested as shown in the first and second line of code shown in FIG. 5C. In this example, SalesPersonWorker is a database field of SalesOrder 204A, e.g., a foreign key to a database record in the database object Worker. In an example, the apparatus 100 may generate the query 114 such as “MySalesOrder.SalesPersonWorker” to retrieve a record from the database object Worker. The apparatus 100 may interactively generate the query 114 with the author when the apparatus 100 encounters the database field “SalesPersonWorker,” which is a foreign key to a record in the database object Worker.

The apparatus 100 may, to determine the example query discussed in FIG. 5C, dynamically determine the entity-relationship graph 116 for objects that are adjacent to the object MySalesOrder. The apparatus 100 may determine the object MySalesOrder may include the foreign key SalesPersonWorker. The apparatus 100 may determine the foreign key SalesPersonWorker is a second database object located within the object Worker. For example, the table Worker may include the column SalesPersonWorker. The apparatus 100 may construct the query 114 as shown in FIG. 5C to retrieve the SalesPersonWorker using the foreign key. Thus, FIGS. 5C and 5B illustrate the syntax of query 114 generated by the apparatus 100 when the foreign key is not used and an instance where the foreign key is used, respectively.

The query 114 generated by the apparatus 100 may be abstract and may retrieve more database values than required or expected by the instructions in the application. In addition, the apparatus 100 may delay retrieval of the database value until the database value is used in an instruction of the application 108 for processing. In other words, the apparatus 100 may delay retrieving the database value until the database value is required in instructions scheduled to be executed. The apparatus 100 may balance the retrieval of the database value to fetch the database value just in time, to, for instance, improve the performance of the application.

Also, the apparatus 100 may retrieve the database value only when the database value is used in an instruction. For example, the SalesPersonWorker information may not be used in the application 108 and thus, the apparatus 100 may retrieve the database value for the Worker. Manager. Manager. Email without retrieving the SalesPersonWorker information.

FIGS. 5D-5F, respectively, illustrate an example of the query 114 and dynamic retrieval of information during authoring. The apparatus 100 may allow generation of the query 114 as shown in FIG. 5D. The query 114 in FIG. 5D is “MySalesOrder.SalesPersonWorker.Manager.Manager.Email” as shown. In FIG. 5E, the apparatus 100 may dynamically determine the entity-relationship graph 116 to identify the objects adjacent or within n-degrees of separation from the first database object. In an example, the apparatus 100 may identify that the database object adjacent to the first database object is the first database object MySalesOrder. The apparatus 100 may display a subset of adjacent database objects based on the application context 122, e.g., Label.Text, which may expect a scalar value. The apparatus 100 may also receive a selection of the subset of adjacent objects to determine the second database object 112, e.g., SalesPersonWorker as shown in FIG. 5F. The apparatus 100 may retrieve the information just in time. For example, only when the apparatus 100 encounters a symbol such as ‘.’ may the apparatus 100 retrieve the metadata to identify the second database object 112. In examples, the metadata may be the database schema 202 as discussed with respect to FIG. 2. Also, the apparatus 100 may retrieve the database schema 202 partially and may stop additional information retrieval once the adjacent objects are identified.

By way of particular example, the apparatus 100 may determine the query 114 to display the email of the manager of a sales associate for an order. The code in the query 114 may be expressed in different instructions that as shown in FIG. 5C. In the application 108, the apparatus 100 may determine that the left-hand pane 410 (FIG. 4) has graphical user interface objects, such as gallery items, and expects Sales Orders 204A as input. The apparatus 100 may use the properties of the graphical user interface object. In other examples, the apparatus 100 may determine the application context 122 from the instructions, “Gallery.Items=SalesOrder” as shown in FIG. 3F. Similarly, the apparatus 100 may determine the application context 122 for the right-hand pane 412 (FIG. 4) from the instructions, “Form.Item=Gallery.SelectedItem” as shown in FIG. 3F. Also, the apparatus 100 may determine the application context 122 based on the instructions “Grid.Items=Gallery.SelectedItem.OrderLine” for the bottom right-hand pane 414.

The apparatus 100 may thus generate the query 114 interactively with the author without using filters, joins, lookups and other functions used in SQL. The apparatus 100 may generate the SQL query based on the query 114.

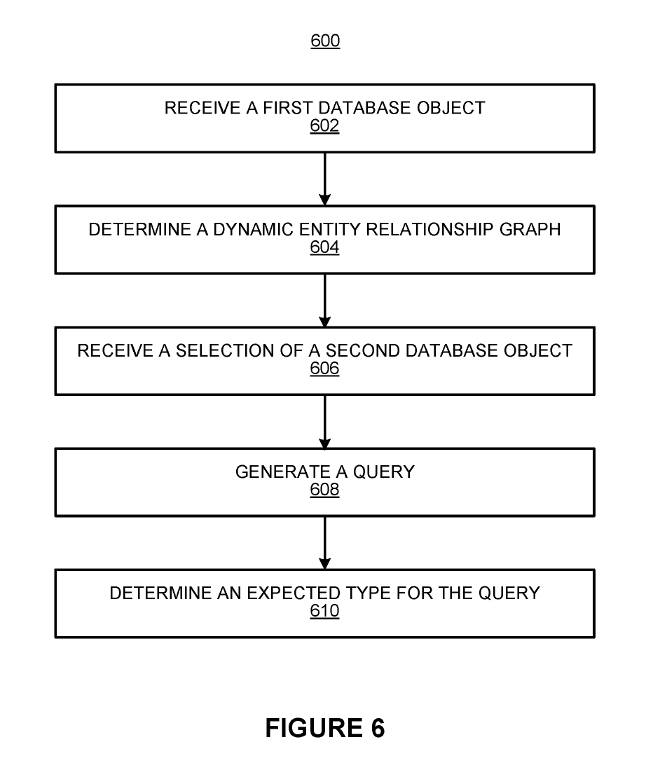

Reference is now made to the methods 600-1000 depicted in FIGS. 6-10. The apparatus 100 or another apparatus may execute any of the methods 600-1000. The methods 600-1000 and operations described herein may be performed by a servers or other types of computers including at least one processor 102 executing machine readable instructions 106, such as shown in FIG. 1. Also, one or more of the operations of the methods 600-1000 described herein may be performed in a different order than shown or may be performed simultaneously or substantially simultaneously.

FIG. 6 shows a flow chart of a method 600 for generating a query according to an embodiment of the present disclosure. At block 602, the processor 102 may receive the first database object 110, for instance, from an author. The first database object 110 may identify an entity in the database 118. In examples, the apparatus 100 may receive the first database object 110 during the generation of an application 108, followed by a symbol such as a full stop ‘.’.

At block 604, the processor 102 may dynamically determine a portion of the entity-relationship graph 116. The entity-relationship graph 116 may describe the relationship between the first database object 110 and a neighboring entity in the database 118 within n-degrees of separation from the first database object 110. For example, the entity-relationship graph 116 may determine the neighboring entities of the first database object 110, such as the children of the first database object 110. In addition, the first database object 110 may be a table with fields and the neighboring entities may include fields in tables. In other words, the neighboring entities may be attributes of the first database object 110. In another example, a field may be a foreign key and the processor 102 may determine an adjacent object in a neighboring entity that includes the fields from another database object with the foreign key.

At 606, the processor 102 may receive a selection of the second database object 112 based on the entity-relationship graph 116. In an example, the selection may be a neighboring entity in the entity-relationship graph 116 determined at block 604. In an example, the processor 102 may show the neighboring entity and may narrow the selection down as the author types letters after a “.” symbol following the first database object 110.

At block 608, the processor 102 may generate a query 114 that includes the first database object 110 and the second database object 112.

At block 610, the apparatus 100 may determine an expected type for the database value that matches the query 114. For example, the expected type may indicate that the database value expected in the application is an alphanumeric string, such as an email address. In another example, the expected type may indicate that the database value expected in the application may be the values in a table.

In an example, the processor 102 may retrieve a set of database values that match the query and the expected type. For example, the processor 102 may execute the query and may determine the type of the received database value. The processor 102 may also determine whether the type of the received database value matches the type of the expected value. The processor 102 may reshape or collapse the database value based on the expected value not matching the type of the expected value.

In examples, the processor 102 may delay generation of the query 114 based on the application context 122. In examples, the processor 102 may selectively retrieve a database value for the query 114, e.g., during execution of the application based on a limited data projection of the data for scheduled instructions of the declarative application. In examples, the processor 102 may identify a second database object 112 using a foreign key in the database.

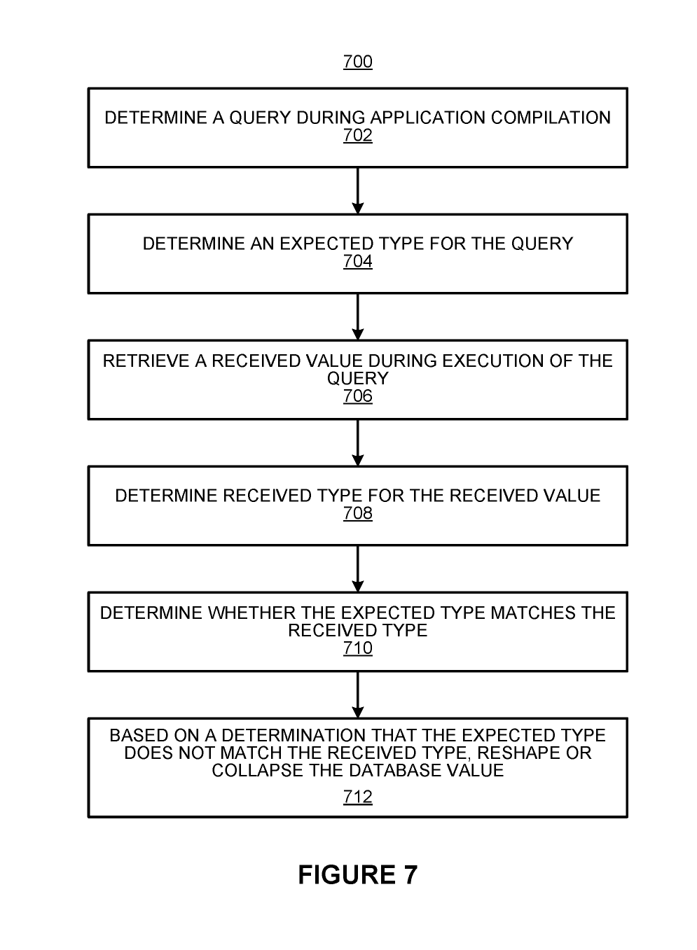

FIG. 7 shows a flow chart of a method 700 for determining the database value of a query 114 according to an embodiment of the present disclosure. At block 702, the processor 102 may, during application compilation, determine the query 114 as described above with reference to any of FIGS. 3A-3D, 4, and 5A-5F. For example, the processor 102 may receive the name of the first database object 110 from an author and may interactively arrive at the query 114. Also, the processor 102 may generate the database query, such as an SQL query 306, corresponding to the query 114.

At block 704, the processor 102 may determine an expected type for the query 114. For example, as described with reference to FIG. 3D, the processor 102 may determine that the Grid.Items property of the object in the application 108 expects the database value to be a table. The application 108 may expect a certain format, certain fields, or the like. For example, as discussed above with reference to FIG. 5A, the application may expect an email address, which may be a string value in a database.

At block 706, the processor 102 may retrieve the database value during execution of the query 306 that corresponds to the query 114 from the database 118.

At block 708, the processor 102 may determine the received type for the received value as described above with reference to FIG. 1.

At block 710, the processor 102 may determine whether the expected type matches the received type.

At block 712, the processor 102 may, based on a determination that the expected type does not match the received type, determine the database value is the unaltered databased value. In addition, the processor 102 may reshape the database value received to a type expected by the application 108. For instance, the processor 102 may reshape the received value when the application 108 expects the data to be in a certain format and the received value is not in the expected format. In other examples, the processor 102 may collapse the received value when the application 108 receives more data than expected. For example, the entire table may be returned instead of a database field, an array may be received instead of a single value, or the like. The processor 102 may collapse the data to remove the data that is not used in the instructions of the application 108 to determine the database value. In another example, the processor 102 may return a result in response to the determination that the expected type matches the received type determine the database value is the unaltered database value.

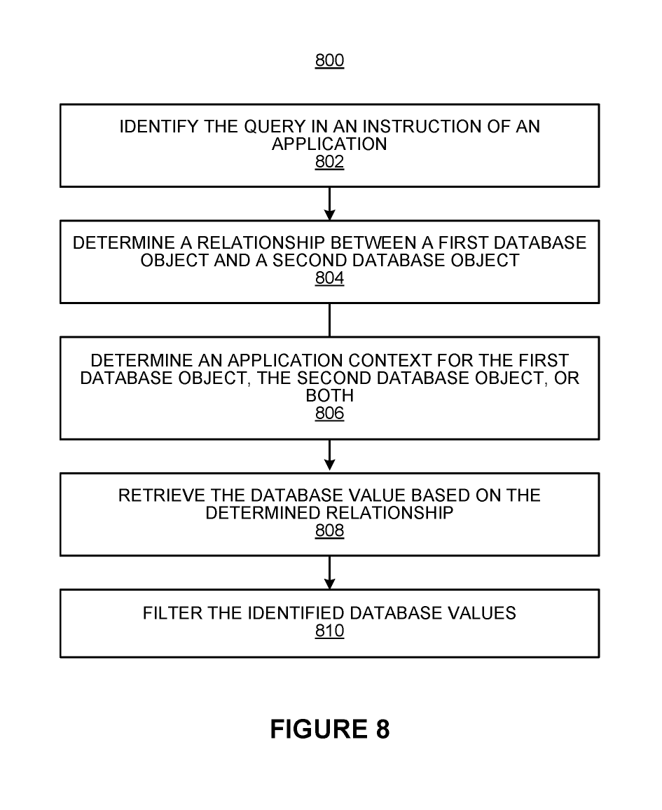

FIG. 8 shows a flowchart of a method 800 for determining the database value of a query 114. At block 802, the processor 102 may identify the query 114 in an instruction of the application 108, which may be a declarative application. The query 114 may be a query 114 as described above with reference to any of FIGS. 3A-3D, 4, and 5A-5F. For example, the processor 102 may receive the name of the first database object 110 from an author and may interactively arrive at the query 114.

At block 804, the processor 102 may determine the relationship between a first database object 110 and a second database object 112 expressed in the query 114. For example, as described with reference to FIG. 5F, the query 114 may be described in dot form. As shown in FIG. 5F, the query 114 may be “SalesOrder.SalesPersonWorker.Manager.Manager.Email”, where the SalesOrder is separated from SalesPersonWorker using the “.”, i.e., dot form. The processor 102 may determine the relationship expressed between SalesOrder and Worker objects in the query 114 to dynamically generate a portion of the entity-relationship graph 116. For example, the processor 102 may determine that the SalesPersonWorker is a child object of the database object SalesOrder in the database. In examples, the processor 102 may determine that the child object in the query 114 is treated as an entity but is in fact a field of the database object SalesOrder. The processor 102 may determine the relationship between the SalesPersonWorker and the Worker object based on the context information from the application, the context information from the dynamically constructed entity-relationship graph 116, context information from other instructions preceding or after the instruction in the application where the query is present, or the like.

The processor 102 may determine that the SalesPersonWorker is a field of the database object SalesOrder. The apparatus 100 may use this information to dynamically generate the entity-relationship graph 116 for the query 114. Additionally, the processor 102 may determine that the child object SalesPersonWorker is a foreign key to a record in the Worker object. The processor 102 may determine the query 114 is “MySalesOrder.SalesPersonWorker” to retrieve a record involving the foreign key to a record in the database object Worker. In examples, the processor 102 may interactively generate this query with the author of the application.

At block 806, the processor 102 may determine the application context 122 for the first database object 110, the second database object 112, or both. The processor 102 may determine the database value from a database 118 that meets the identified relationship between the first database object 110 and the second database object 112. The processor 102 may generate a database query in a format expected by the database 118, such as an SQL query. As discussed above with reference to FIG. 1, the application context 122 may be context based on the application, context from the database schema, context from query history, or the like.

At block 808, the apparatus 100 may retrieve the database value based on the determined relationship. For example, the apparatus 100 may retrieve the database value based on the database query, such as the generated SQL query.

Optionally, at block 810, the processor 102 may further filter the identified the database value based on the application context 122. For example, the processor 102 may determine the database value utilized in a graphical display and the database value used as intermediate steps to obtain the database value as described with reference to FIGS. 5B and 5C. The processor 102 may retrieve the database value that the application 108 requires in scheduled instructions or requires to continue execution of the application 108. In examples, the processor 102 may perform lazy evaluation of the query. In other words, the processor 102 may delay evaluation of the query until the database value is to be utilized fora scheduled execution. In an example, the application context 122 may be based on the query in the application 108. In another example, the application context 122 may be based on the query of an author.

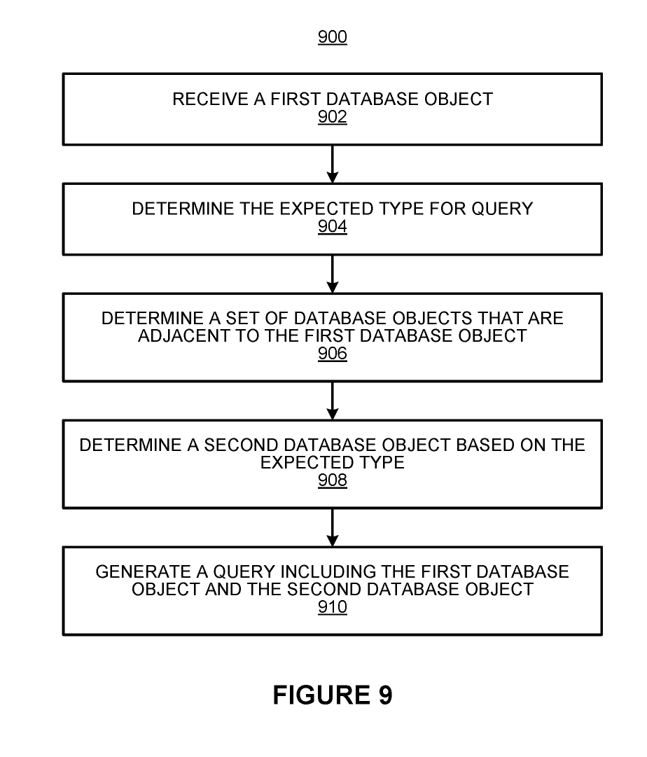

FIG. 9 shows a flowchart of a method 900 for generating a query 114 according to an embodiment of the present disclosure. At block 902, the processor 102 may receive a first database object 110 for the application 108. As described above with reference to FIG. 1, the apparatus 100 may receive the first database object 110.

At block 904, the processor 102 may determine the expected type of the database value when the query 114 is executed to populate the database value in the specific instruction of the application 108. As described above with reference to FIG. 1, the expected type may be based on the context of the query 114. For example, the properties of a graphical user interface object may determine the context of the query 114. Examples of context may include a grid element to display a table, a label element to display a single value, or the like.

At block 906, the processor 102 may determine a set of database objects that are adjacent to the first database object 110 in the entity-relationship graph 116 as described above with reference to FIG. 1. For instance, the processor 102 may determine a set of database objects that are adjacent to the first database object 110 in the entity-relationship graph 116 that may be dynamically determined without a priori knowledge of the database schema.

At block 908, the processor 102 may determine a second database object 112 based on the expected type in the set of database objects. For example, the entity-relationship graph 116 may indicate neighbors of only one type, e.g., a field in a database table. Thus, the processor 102 may determine the second database object 112 based on the expected type and the set of database objects that are adjacent to the first database object 110. For example, the processor 102 may filter the set of database objects based on the expected type.

At block 910, the processor 102 may generate a query including the first database object 110 and the second database object 112. For instance, the processor 102 may generate the query 114 using the first database object 110 and the second database object 112. The processor 102 may generate a query for a data service 120 or the database 118 based on the query 114.

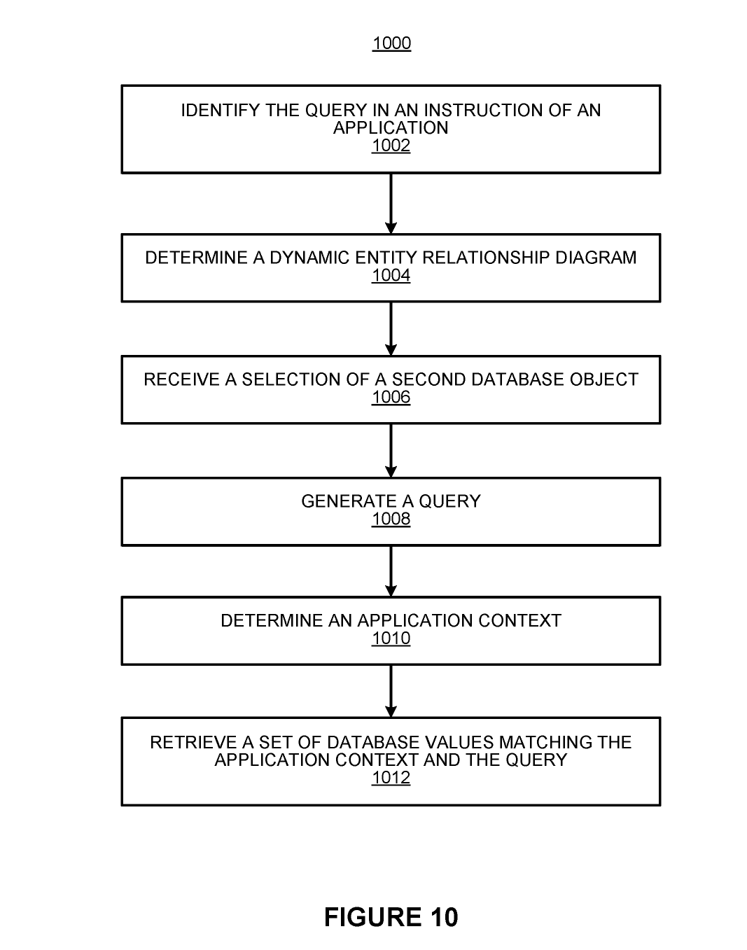

FIG. 10 shows a flowchart of a method 1000 for determining the database value of a query 114. At block 1002, the processor 102 may identify the query 114 in an instruction of the application 108, which may be a declarative application. The query 114 may be a query 114 as described above with reference to any of FIGS. 3A-3D, 4, and 5A-5F. For example, the processor 102 may receive the first database object 110 from an author and may interactively arrive at the query 114. The first database object 110 may the name of an entity such as a table, row or column in the database or a relationship between the entities in the database or an attribute of an entity or an attribute of the relationship.

At block 1004, the processor 102 may determine the entity-relationship graph 116 including the first database object 110 and the neighboring entity within n-degrees of separation from the first database object 110 in the database 118. For example, as described with reference to FIG. 5F, consider the query 114 described in dot form such as “SalesOrder.SalesPersonWorker. Manager. Manager. Email”, where the SalesOrder is separated from SalesPersonWorker using the “.”, e.g., dot form. The processor 102 may receive the first database object SalesOrder. The SalesOrder may indicate the name of a table in the database 118. The processor 102 may also determine the neighbor of the first database object 110. In an example, the neighboring entities may include the child objects SalesOrderID 206A, Account 208A, Account Contact 210A, or the like. The child objects may be attributes of the SalesOrder table, such as rows or columns in the table. The processor 102 may also identify any foreign keys in the child objects to determine additional neighboring entities that are within n-degrees of separation from the first database object 110.

At block 1006, the processor 102 may receive a selection from the author of the neighboring entity identified in the entity-relationship graph 118. In an example, the author may type in a “.” after the SalesOrder object. The processor 102 may also provide the author with the neighbor determined at block 1004. The author may type in a few characters until a unique match is found amongst the neighboring entity to select the second database object 112.

Optionally, the processor 102 may continue to receive a selection of an additional database object that is a neighboring entity of the second database object 112 to generate the query 114. For example, the processor 102 may determine the relationship expressed between SalesOrder and Worker objects in the query 114 to dynamically generate a portion of the entity-relationship graph 116. For example, the processor 102 may determine that the SalesPersonWorker is a child object of the database object SalesOrder in the database. In examples, the processor 102 may determine the child object in the query 114 is treated as an entity but is in fact a field of the database object SalesOrder. The processor 102 may determine the relationship between the SalesPersonWorker and the Worker object based on the application context 122, the context information from the dynamically constructed entity-relationship graph 116, context information from other instructions preceding or after the instruction in the application where the query 114 is present, or the like.

The processor 102 may determine that the SalesPersonWorker is a field of the database object SalesOrder. The processor 102 may use this information to dynamically generate the entity-relationship graph 116 for the query 114. Additionally, the processor 102 may determine that the child object SalesPersonWorker is a foreign key to a record in the Worker object. The processor 102 may determine that the query 114 is “MySalesOrder.SalesPersonWorker” to retrieve a record involving the foreign key to a record in the database object Worker. In examples, the processor 102 may interactively generate the query 114 with the author of the application 108.

At block 1008, the processor 102 may generate a query 114 including the first database object 110 and the second database object 112 based on the information available from the previous blocks. In an example, the processor 102 may convert the dot form of the query 114 into a SQL format expected by an SQL database.

At block 1010, the processor 102 may determine an application context 122. In examples, the processor 102 may determine an application context 122 of the first database object 110. As described above with reference to FIG. 1, the application context 122 may be the context in which the first database object 110 appears in the declarative application 108. For example, the processor 102 may determine the application context 122 based on the instructions in the declarative application 108. The processor 102 may determine the application context 122 using the context provided by the instructions before and after the first database object 110. In other examples, the processor 102 may determine the application context 122 based on the context of the database schema. In other examples, the processor 102 may determine the application context 122 based on the context determined from a database object in the database 118. In still other examples, the processor 102 may determine the application context 122 based on the context determined from a database field in the database object 110.

At block 1012, the processor 102 may retrieve the set of database values matching the application context 122 and the query 114. The processor 102 may filter the database value received during execution of the query 114 based on the application context 122. For example, the processor 102 may determine the database value utilized in a graphical display and the database value used as intermediate steps to obtain the database value as described with reference to FIGS. 5B and 5C. The processor 102 may retrieve the database value that the application 108 is to use in scheduled instructions or is to use to continue execution of the application 108. In examples, the processor 102 may perform lazy evaluation of the query 114. In other words, the processor 102 may delay evaluation of the query 114 until the database value is to be utilized for a scheduled execution. In an example, the application context 122 may be based on the query 114 in the application 108. In another example, the application context 122 may be based on the query 114 of an author.

Some or all of the operations set forth in the methods 600-1000 may be included as utilities, programs, or subprograms, in any desired computer accessible medium. In addition, the methods 600-1000 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting but is offered as an illustrative discussion of aspects of the disclosure.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
at least one processor; and
a memory on which is stored machine readable instructions that are to cause the at least one processor to:
receive a first database object in a declarative application;
determine an entity-relationship graph with a neighbor within n-degrees of separation from the first database object in a database;
receive a selection of a second database object based on the entity-relationship graph;
generate a query including the second database object; and
determine an expected type for a database value that matches the query.

2. The apparatus of claim 1, further comprising machine readable instructions to cause the at least one processor to:
retrieve a set of database values that match the query and the expected type.

3. The apparatus of claim 1, wherein the entity-relationship graph is generated based on an application context.

4. The apparatus of claim 1, further comprising machine readable instructions to cause the at least one processor to:
delay generation of the query based on an application context.

5. The apparatus of claim 1, further comprising machine readable instructions to cause the at least one processor to:
selectively retrieve the database value for the query during execution of the declarative application based on a limited data projection of the data for scheduled instructions of the declarative application.

6. The apparatus of claim 1, wherein the machine-readable instructions to cause the at least one processor to determine an entity-relationship graph with a neighbor within n-degrees of separation from the first database object in a database includes:
determine a database object based on a foreign key in the database.

7. The apparatus of claim 1, further comprising machine readable instructions to cause the at least one processor to:
receive the database value responsive to execution of the query;
determine a received type for the received database value;
determine whether the received type matches the expected type; and
in response to the received type not matching the expected type, reshape the received database value to match the expected type.

8. The apparatus of claim 1, further comprising machine readable instructions to cause the at least one processor to receive a database value responsive to execution of the query;
receive the database value responsive to execution of the query;
determine a received type for the received database value;
determine whether the received type matches the expected type; and
in response to the received type not matching the expected type, collapse a received value by discarding an extraneous value to match the expected type.

9. The apparatus of claim 1, further comprising machine readable instructions to cause the at least one processor to:
receive the database value responsive to execution of the query;
determine a received type for the received database value;
determine whether the received type matches the expected type; and
in response to the received type matching the expected type, retain the database value without alteration.

10. The apparatus of claim 1, further comprising machine readable instructions to cause the at least one processor to:
receive the database value responsive to execution of the query;
determine whether the received database value includes an array of values; and
in response to the received value including an array of values, select a value from the array of values based on an application context.

11. The apparatus of claim 1, further comprising machine readable instructions to cause the at least one processor to:
selectively retrieve the database value for the query during execution of the declarative application based on a limited data projection of the data for scheduled instructions of the declarative application.

12. An apparatus comprising:
at least one processor; and
a memory on which is stored machine readable instructions that are to cause the at least one processor to:
receive a first database object;
determine an entity-relationship graph including the first database object as used in a declarative application and a neighbor within n-degrees of separation from the first database object;
receive a selection of a second database object based on the entity-relationship graph;
generate a query including the first database object and the second database object;
determine an application context between the first database object and the second database object as used in the declarative application; and
retrieve a set of database values matching the query and the application context.

13. The apparatus of claim 12, further comprising machine readable instructions to cause the at least one processor to:
determine the application context based on a previous query in the application.

14. The apparatus of claim 12, further comprising machine readable instructions to cause the at least one processor to:
determine the application context based on a previous query of an author of the application.

15. The apparatus of claim 12, further comprising machine readable instructions to cause the at least one processor to:
determine an expected type for database entry that matches the query;
receive a database value responsive to execution of the query;
determine a received type for the received database value;
determine whether the received type matches the expected type;
in response to the received type matching the expected type, retain the database value without alteration.

16. The apparatus of claim 12, further comprising machine readable instructions to cause the at least one processor to:
determine an expected type for database entry that match the query;
receive a database value responsive to execution of the query;
determine a received type for the received database value;
determine whether the received type matches the expected type;
in response to the received type not matching the expected type, collapse a received value to match the expected type.

17. The apparatus of claim 12, further comprising machine readable instructions to cause the at least one processor to:
selectively retrieve a database value for the query during execution of the declarative application based on a limited data projection of the data for scheduled instructions of the declarative application.

18. The apparatus of claim 12, further comprising machine readable instructions to cause the at least one processor to:
identify the second database object based on a foreign key in a database.

19. The apparatus of claim 12, wherein the entity-relationship graph includes context determined from a database schema.

20. A computer-implemented method comprising:
receiving, by at least one processor, a first database object in a declarative application;
determining, by the at least one processor, an entity-relationship graph including the first database object and a neighboring object within n-degrees of separation from the first database object in a database;
displaying, by the at least one processor, the neighboring object interactively to an author;
receiving, by the at least one processor, a selection of a second database object based on the entity relationship graph;
generating, by the at least one processor, a query including the first database object and the second database object;
determining, by the at least one processor in the declarative application, an application context between the first database object and the second database object; and
retrieving, by the at least one processor, a set of database entries matching the query and the application context.
